(19) United States
(12) Patent Application Publication
(10) Pub. No.: US 2003/0001864 A1
(43) Pub. Date: Jan. 2, 2003

(54) Method and system for manipulation of garphics information

(75) Inventor: Frederic Jean-Luc Charpentier, Ottawa (CA)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BITFLASH GRAPHICS, INC., Gloucester (CA)

(21) Appl. No.: 10/180,101

(22) Filed: Jun. 27, 2002

Related U.S. Application Data
(60) Provisional application No. 60/301,482, filed on Jun. 29, 2001.
(60) Provisional application No. 60/301,423, filed on Jun. 29, 2001.

(51) Int. Cl. G09G 5/00

(52) U.S. Cl. 345/619

(57) ABSTRACT

Manipulation of graphics information according to a computing device on which graphics information is to be displayed is performed. The capabilities of the computing device are used to form a set of constraints for the graphics information obtained from a content provider. These constraints take into consideration such factors as display characteristics of the computing device, processing power, available memory and communication capacity. The graphics information is manipulated to conform to the set of constraints, resulting in graphics information that can be displayed and interpreted by the computing device.

### CROSS REFERENCE TO RELATED APPLICATIONS

The present application claims priority from U.S. provisional patent application serial No. 60/301,482 filed on Jun. 29, 2001. United States Patent application entitled “Method and System for Displaying Graphics Information” was filed concurrently herewith and claims priority from U.S. provisional patent application serial No. 60/301,423 filed on Jun. 29, 2001.

### FIELD OF THE INVENTION

The present invention is directed towards manipulating graphics information according to characteristics of a device for displaying the graphics information.

### BACKGROUND OF THE INVENTION

With the increasing diversity of computing devices capable of displaying graphics information there is an increased demand to provide such information in a format that can be interpreted by each computing device. This has resulted in the development of a wide variety of formats for graphics information and often the provision of a multiplicity of the graphics information for each format. The resulting format is often less than optimal for each computing device and adds the complexity of requiring conversion of the graphics information into different formats at the time of development. The distinct discrete formats do not take into consideration the capabilities of the computing device, such as the display characteristics, processing power, available memory and communication capacity.

### SUMMARY OF THE INVENTION

In accordance with an aspect of the present invention there is provided a method of modifying graphics information to be displayed on a computing device having a set of display characteristics representing display capabilities of the computing device, said method comprising: determining a scheme by which to conform characteristics of the graphics information to the set of display characteristics; harmonizing the characteristics of the graphics information to the set of display characteristics according to said scheme to provide the graphics information in a format adapted for display on the computing device.

In accordance with another aspect of the present invention there is provided a system for modifying graphics information to be displayed on a computing device having a set of display characteristics representing display capabilities of the computing device, said system comprising: a conformation mechanism for assessing the set of display characteristics and characteristics of the graphics information to determine a scheme by which to conform the characteristics of graphics information to the set of display characteristics; a graphics modification mechanism for harmonizing the characteristics of the graphics information to the set of display characteristics according to said scheme; and a controller for orchestrating modification of the graphics information to provide the graphics information in a format adapted for display on the computing device.

In accordance with a further aspect of the present invention there is provided a computer readable medium having stored thereon computer-executable instructions for modifying graphics information to be displayed on a computing device having a set of display characteristics representing display capabilities of the computing device, said computer-executable instructions comprising: determining a scheme by which to conform characteristics of the graphics information to the set of display characteristics; harmonizing the characteristics of the graphics information to the set of display characteristics according to said scheme to provide the graphics information in a format adapted for display on the computing device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be described in conjunction with the drawings in which:

FIG. 1 represents an example of a suitable computing environment in which the present invention may be implemented;

FIG. 2 is a system diagram of a system for manipulating graphics information for display according to an embodiment of the present invention;

FIG. 3 is a system diagram of a graphics customization mechanism of the system of FIG. 2; and

FIGS. 4A and B show a flow diagram representing a method of manipulating graphics information for display according to an embodiment of the present invention.

### DETAILED DESCRIPTION

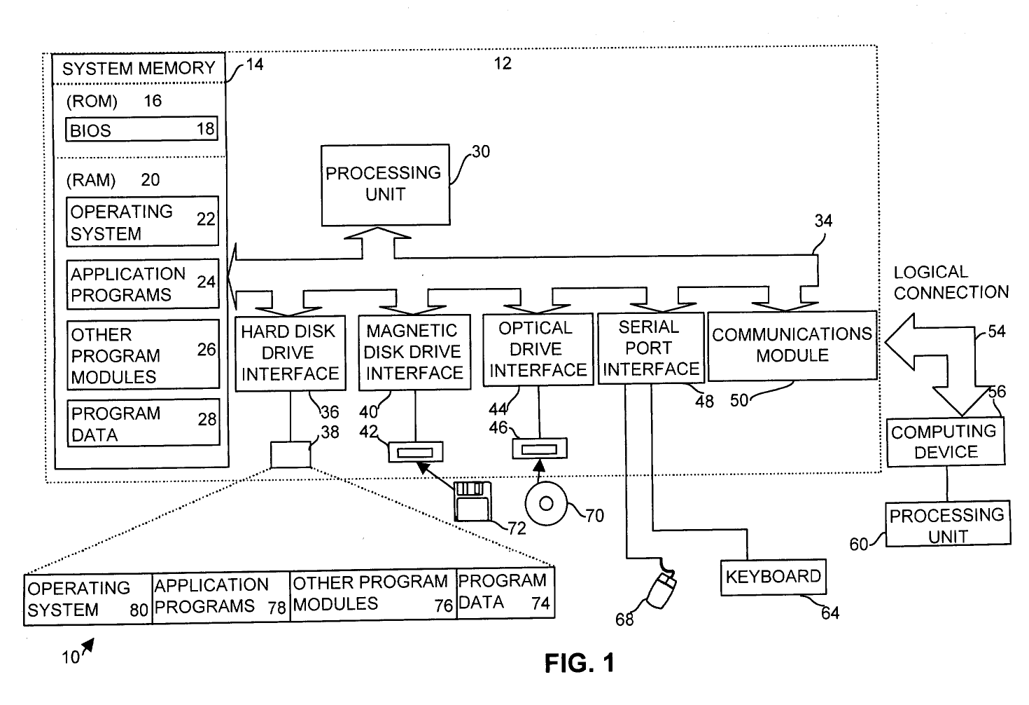

FIG. 1 and the associated description represent an example of a suitable computing environment 10 in which the present invention may be implemented. While the invention will be described in the general context of computer-executable instructions of a computer program, the present invention can also be implemented in combination with other program modules.

Generally, program modules include routines, programs, components, data structures and the like that perform particular tasks or implement particular abstract data types. Further, the present invention can also be implemented using or in combination with other computer system configurations, including hand-held devices, multiprocessor systems, microprocessor-based or programmable consumer electronics, minicomputers, mainframe computers, and distributed computing environments where program modules may be located in both local and remote memory storage devices.

With reference to FIG. 1, the present invention may be implemented within a general purpose computing device in the form of a conventional computer 12, including a processing unit 30, a system memory 14, and a system bus 34 that couples various system components including the system memory 14 to the processing unit 30. The system memory 14 includes read only memory (ROM) 16 and random access memory (RAM) 20.

A basic input/output system 18 (BIOS), containing the basic routines that help to transfer information between elements within the computer 12 (e.g. during start-up) is stored in ROM 16. The computer 12 further includes a hard disk drive 38 for reading from and writing to a hard disk (not shown), a magnetic disk drive 42 for reading from or writing to a removable magnetic disk 72, and an optical disk drive 46 for reading from or writing to a removable optical disk 70 such as a CD ROM or other optical media, all of which are connected to the system bus 34 by respective interfaces 36, 40, 44. The drives 38, 42, 46 and their associated computer-readable media 72, 70 provide nonvolatile storage of computer readable instructions, data structures, program modules and other data for the computer 12. Although the exemplary environment described herein employs certain disks, it should be appreciated by those skilled in the art that other types of computer readable media for storing data may also be employed.

A number of program modules may be stored on the disks 72, 70, ROM 16 or RAM 20, including an operating system 22, one or more application programs 24, other program modules 76, and program data 74. Commands and information may be entered into the personal computer 12 through input devices (e.g. a keyboard 64, a pointing device 68, a microphone, joystick, etc.). These input devices may be connected to the processing unit 30 through a serial port interface 48, a parallel port, a game port or a universal serial bus (USB). A monitor 52 or other type of display device may also connected to the system bus 34 via an interface, such as a video adapter 32.

The computer 12 operates in a networked environment using logical connections to one or more remote computing devices 56, such as another personal computer, a handheld device, a mini computer, microprocessor-based or programmable consumer electronics or any other such device capable of displaying graphics information. The logical connection depicted in FIG. 1 is a communications network 54, which may be a wireless network, a packet-switching network, etc.

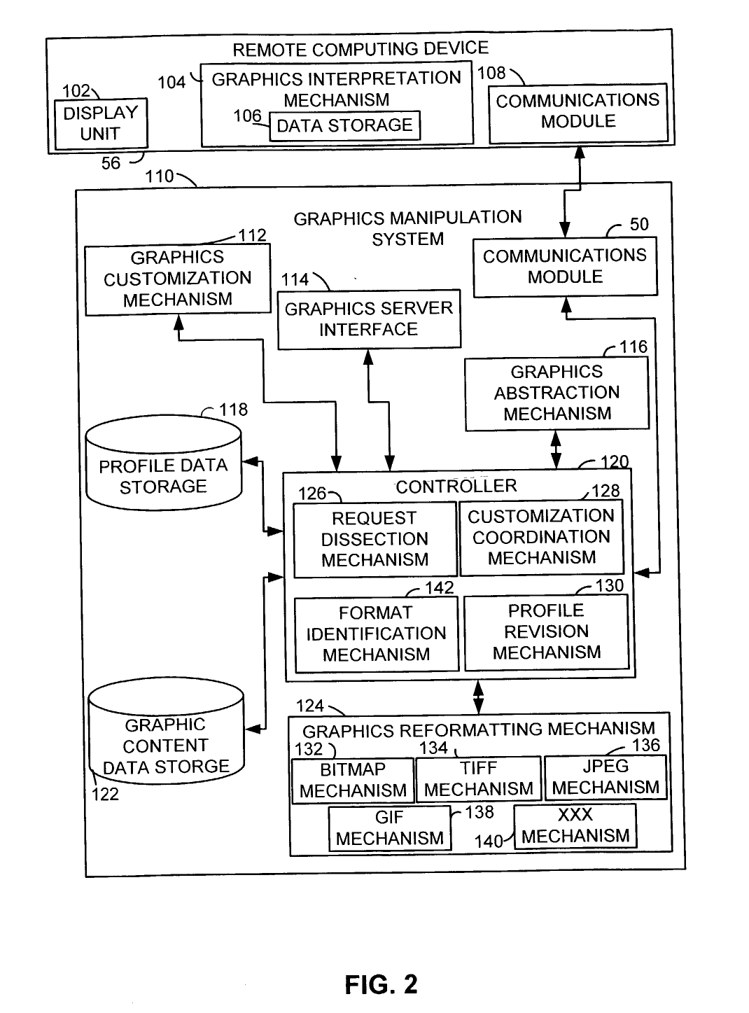

The computer 12 is connected to the communications network 54 through a communications module 50. The operations of the present invention may be distributed between the two computers 12, 56, such that one acts as a server and the other as a client (see FIG. 2). Operations of the present invention for each computer 12, 56 (client and server) may be stored in RAM 20 of each computer 12, 56 as application programs 24, other program modules 26, or on one of the disks 38, 42, 46. It will be appreciated that the network connections shown are exemplary and other means of establishing a communications link between the computers may be used.

FIG. 2 shows a graphics manipulation system 110 for manipulating graphics information to be displayed on a remote computing device 56 according to an embodiment of the present invention. The graphics information may include, for example, text, icons and other images, graphical user interfaces, etc. The graphics manipulation system 110 may be embodied in various components of the computer 12 including application programs 24, other program modules 26, program data 28, RAM 20 or other disks 72, 70, the communications interface 50 and the processing unit 30. The graphics manipulation system 110 translates graphics information obtained from a graphics server (not shown) into a form that can be used and understood by the remote computing device 56 for displaying the graphics information. The translation of the graphics information is akin to a customization of the graphics information according to a device on which it will be displayed, the remote computing device 56. This customization may take into account display, transmission and processing capabilities of the remote computing device 56.

The remote computing device 56 requests graphics information to be displayed thereon. The request for the graphics information may be placed directly with the graphics manipulation system 110, which retrieves the graphics information from the graphics server through the communications network 54. The graphics server may be any computing device from which graphics information can be obtained, for example, a web server, a database server, etc. Alternatively, the remote computing device 56 may request the graphics information from the graphics server, which requests manipulation of the graphics information by the graphics manipulation system 110. The graphics information may then be supplied to the remote computing device 56 directly from the graphics manipulation system 110 or through the graphics server. The exemplary embodiment in FIG. 2 depicts the case where graphics information is requested and received from the graphics manipulation system 110.

The remote computing device 56 may be any device having a display unit 102, a communications module 108 and a graphics interpretation mechanism 104 with a data storage 106. The remote computing device 56 may be, for example, a desktop computer, a handheld computer, a personal digital assistant (PDA), a portable/cellular telephone with display, etc. The communications module 108 requests and receives the graphics information from the graphics manipulation system 110. Communication between the remote computing device 56 and the graphics manipulation system 110 is a logical connection that may be through the communications network 54, such as a wireless communication means, a network connection such as a local area network, or a physical link (e.g. the remote computing device 56 and the graphics manipulation system 110 reside on the same physical computing entity or in close proximity to each other). The graphics interpretation mechanism 104 interprets the graphics information received from the communications module 108 to display the graphics information on the display unit 102. The graphical interpretation may involve recognizing objects such as various geometric shapes (e.g. line, circle, polygon, etc.) and/or complex effects (e.g. anti-aliasing, semi-transparency, etc.) and generating the recognized objects on the display unit 102.

The graphics manipulation system 110 communicates with the remote computing device 56 via a communications module 50. The communications module 50 receives requests from the remote computing device 56 for graphics information. Once this graphics information has been adapted for display by the remote computing device 56 the communications module 50 forwards the graphics information to the remote computing device 56 in response to the request. Although a single remote computing device 56 is depicted in FIG. 2 it will be recognizable by one skilled in the art that the communications module 50 may respond to the requests of multiple remote computing devices 56 of various types.

A controller 120 in the graphics manipulation system 110 is responsible for the coordination and management of request fulfillment for graphics information.

A request dissection mechanism 126 in the controller 120 extracts various components included in each request for graphics information. Each request made for graphics information includes a location of the graphics information (e.g. an address for the graphics server), identification information for the graphics information and characteristic information for the remote computing device 56. The characteristic information summarizes the capabilities of the remote computing device 56 and may include such information as device type, amount of memory available (heap and storage), data transmission speed, processing speed and display characteristics. The display characteristics may include display size, color system, color depth, screen resolution (e.g. dots per inch), significant word/byte order (e.g. big-endian, little endian), and intrinsic graphics interpretation mechanism capabilities, such as support for basic shapes, complex shapes, bitmaps, effects, paints, strokes, etc. This information forms a device profile that is used to translate the graphics information into a form that is customized to the capabilities of the remote computing device 56. The extracted request components (i.e. graphics information location and identification and characteristic information for the remote computing device 56) are provided to a customization coordination mechanism 128 and a profile revision mechanism 130 for further processing.

The characteristic information for the remote computing device 56 is used by the profile revision mechanism 130 in the controller 120 to create and maintain a device profile for the remote computing device 56 in a profile data storage 118. The profile data storage 118 contains profiles for devices that request graphics information from the graphics manipulation system 110. The profiles for devices may include such information as the device type, amount of memory, data transmission speed, processing speed and display characteristics.

The profile revision mechanism 130 extracts the type of device information from the characteristic information and determines whether a device profile currently exists in the profile data storage 118 for the given device type. If a profile for the given device type currently exists then the profile revision mechanism 130 revises the information in the profile data storage 118 according to differences between the device profile in the profile data storage 118 and the characteristic information in the request. If a profile for the device does not exist in the profile data storage 118 then the profile revision mechanism 130 creates one based on the characteristic information in the request.

The customization coordination mechanism 128 in the controller 120 manages fulfillment of the request including transformation of the graphics information into a form that will be adapted according to capabilities of the remote computing device 56. The customization coordination mechanism 128 searches a graphic content data storage 122 to determine if the graphics information has been previously requested and stored therein and if the requesting device was of the same type as the remote computing device 56. A graphic content data storage 122 may contain previously obtained graphics information and/or previously customized graphics information. Graphics information from the graphics content data storage 122 is customized under the management of the customization coordination mechanism 128 according to the device type of the remote computing device 56. Graphics information in the graphics content data storage 122 that has already been customized for the device type of the remote computing device 56 is in a form adapted for the capabilities of the remote computing device 56 and can be forwarded thereto in response to the request.

If the graphics content data storage 122 does not contain graphics information that corresponds with the graphics information requested, the location and identification of the graphics information extracted from the request are used by the customization coordination mechanism 128 to retrieve the graphics information from the graphics server. The customization coordination mechanism 128 has the graphics information converted to a first format, from which an abstract representation can be made, and then has the abstract representation translated into a form adapted for the capabilities of the remote computing device 56.

A graphics server interface 114 is used by the customization coordination mechanism 128 to communicate with the graphics server for obtaining the graphics information. The graphics server interface 114 contacts the graphics server at the location indicated in the request for graphics information. The graphics information corresponding with the identification information in the request is then requested from the graphics server. The graphics server interface 114 receives the graphics information from the graphics server and provides this information to the customization coordination mechanism 128. The graphics server interface 114 and the controller 120 together function for obtaining the graphics information.

For graphics information that has not been customized (i.e. from the graphics content data storage 122 or the graphics server), the format of the graphics information is determined by a format identification mechanism 142. The format identification mechanism 142 obtains the graphics information from the customization coordination mechanism 128. The format identification mechanism 142 determines the format of the graphics information (i.e. bitmap, JPEG, TIFF, GIF, html, etc.) to allow for conversion of the graphics information from its current format to a first format. The format identification mechanism 142 examines the graphics information to locate known identifiers for various format. For example, the graphics information may have a filename that could be used to indicate the format of the graphics information (e.g. a file names landscape.jpg suggests that the file may be in a JPEG format). The format identification mechanism 142 may also examine a format signature in a header of the graphics information to try to determine the format thereof. The graphics information may be in any of a number of format, for example, bitmap, JPEG, TIFF, GIF, Scalable Vector Graphics (SVG), Computer Graphics Metafile (CGM), Enhanced Metafile Format (EMF), Portable Document Format (PDF), etc.

The graphics information is provided to a graphics reformatting mechanism 124 along with information on the current format. The graphics reformatting mechanism 124 transforms the format of the graphics information into the first format. The graphics reformatting mechanism 124 contains multiple format-specific mechanisms 132 to 140 for performing this function. Each of these format-specific mechanisms 132 to 140 is specific to the current format of the graphics information. For example, a bitmap mechanism 132 converts graphics information in a bitmap format into the first format; a TIFF mechanism 134 converts graphics information in a TIFF format into the first format; a JPEG mechanism 136 converts graphics information in a JPEG format into the first format; a GIF mechanism 138 converts graphics information in a GIF format into the first format, etc. Each of the mechanisms 132 to 140 can be any of a number of well known file format conversion mechanisms. In this manner graphics information in multiple formats can be converted into a single format, the first format. The graphics information in the first format is provided to the customization coordination mechanism 128 from the graphics reformatting mechanism 124. The first format should represent most of the vector graphics, bitmap graphics and document formatting in the graphics information. The grammar of the first format should also enable a representation of the graphics information that efficiently stores and manipulates the graphics information as well as enable easy construction of an abstract representation of the graphics information. The first format may be, for example, a vector based on the W3C Scalable Vector Graphic specification, CGM, PDF, etc.

A graphics abstraction mechanism 116 receives the graphics information in the first format from the customization coordination mechanism 128 and creates an abstract representation of the graphics information. The abstract representation illustrates each entity in the graphics information as an object and shows the relationship between different objects. For example, a circle and all information relating to the display of the circle, such as, size, fill, line thickness, etc., may be considered to be an object. The abstract representation may take the form of, for example, a tree. The first format should enable construction of the abstract representation. The abstract representation offers a view of the graphics information that is conducive to simplification, reduction or revision of the graphics information.

A graphics customization mechanism 112 receives the abstract representation of the graphics information from the customization coordination mechanism 128 for manipulating the form of the graphics information into one that can be transmitted to the remote computing device 56 and displayed thereon. The graphics customization mechanism 112 produces graphics information in a second format that may vary according to the device type of the remote computing device 56. The second format is independent of the capabilities or device type of the remote computing device 56. The manipulation of the graphics information is based on the capabilities of the remote computing device 56 as determined from a device profile in the profile data storage 118 for the remote computing device type. The manipulations may also be performed to increase a speed with which the graphics information may be sent to the remote computing device 56 or a speed with which the graphics information is displayed on the computing device 56. The actions involved in the manipulations may include removing information that cannot be displayed on the remote computing device 56 (e.g. color information if the display unit 102 is grayscale), and other information that describes or verifies the graphics information but is not used for display purposes. The graphics information in the second format may be simplified but still maintain a visual representation similar to the graphics information in the original format from the graphics server. The graphics customization mechanism 12 functions to conform the graphics information to a format adapted for the capabilities of the remote computing device 56 by assessing manipulations to be made and then harmonizing the graphics information with the capabilities of the remote computing device 56.

The graphics information may be stored in the graphic content data storage 122 by the customization coordination mechanism 128 after it has been received from the graphics server (i.e. stored in a format that is not customized for a device type). The graphics information may also be stored in the graphic content data storage 122 by the customization coordination mechanism 128 after it has been transformed into the second format by the graphics customization mechanism 112.

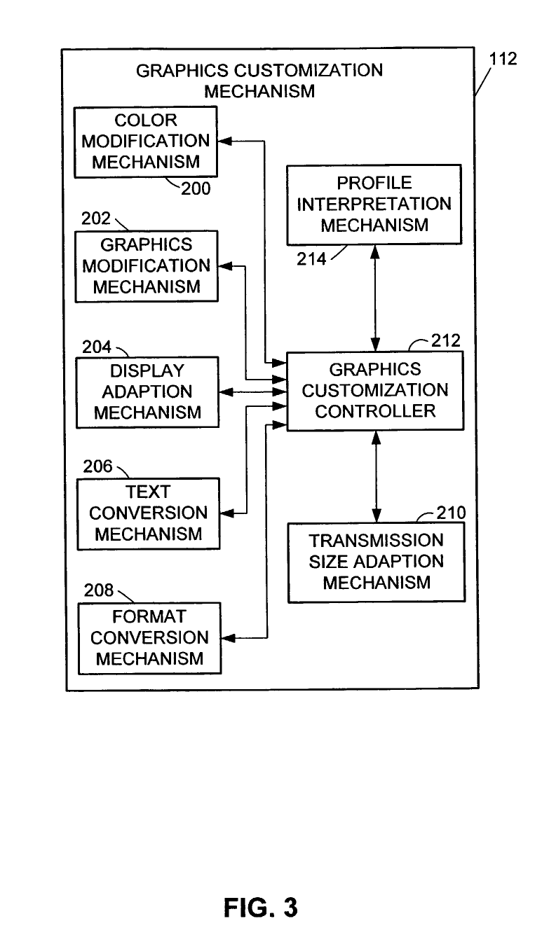

FIG. 3 is a system diagram of the graphics customization mechanism 112 of the graphics manipulation system 110. A graphics customization controller 212 receives the abstract representation and information on the remote computing device profile from the customization coordination mechanism 128 in the controller 120. The graphics customization controller 212 manages the process of transforming the abstract representation into graphics information in the second format based on the device profile for the remote computing device 56. The graphics information in the second format includes rendering processes that can be performed prior to interpretation by the graphics interpretation mechanism 104 in the remote computing device 56.

Information on the remote computing device profile is provided by the graphics customization controller 212 to a profile interpretation mechanism 214. The information on the remote computing device profile may be the device profile as it is stored in the profile data storage 118 or it may comprise identification information sufficient for the profile interpretation mechanism 214 to retrieve the device profile from the profile data storage 118. The profile interpretation mechanism 214 construes the device profile or characteristics of the remote computing device 56 to create a set of constraints for the graphics information that will be returned to the remote computing device 56. That is, the profile interpretation mechanism 214 determines the capabilities of the remote computing device 56 and formulates constraints to ensure that these capabilities will not be exceeded or that demand on the remote computing device 56 resources will not exceeded a given threshold (e.g. 70% of available resources, etc). The set of constraints may include display size, graphics information file size, display colors, etc.

The set of constraints is provided to the graphics customization controller 212 to conform the abstract representation to these constraints. A mechanism may exist in the graphics customization mechanism 112 to conform the abstract representation to each constraint (i.e. a mechanism corresponding to each constraint). The graphics customization controller 212 determines a sequence of manipulations by which the set of constraints will be satisfied. This sequence of manipulations includes information on the type of transformations to be performed by each manipulation mechanism 200 to 210 and an order for performing each transformation. The graphics customization controller 212 performs the sequence of manipulations by successively passing the abstract representation with modifications from mechanism 200 to 210 to each mechanism 200 to 210 indicated in the sequence. When providing each mechanism 200 to 210 with the abstract representations, the graphics customization controller 212 also supplies information on the type of manipulation to be performed.

Each mechanism 200 to 210 receives the abstract representation with information on the type of manipulations that the mechanism 200 to 210 is to perform. The manipulations may be performed in a determined order, either as indicated by the graphics customization controller 212 or determined by the mechanism 200 to 210. A color modification mechanism 200 manipulates color, shading, and filling information in the abstract representation. The manipulations of color, shading and filling are performed to align color information for the abstract representation with the capability of the display unit 102. Manipulation of the color information by the color modification mechanism 200 may involve changing the colors present in the abstract representation or changing the manner in which colors are represented. Changing the colors present in the abstract representation may be performed to convert the complexity of the color information in the graphics information embodied by the abstract representation and to unify the color presentation for multiple pages or multiple files of graphics information. The color information in the abstract representation is in the same form as the color information of the original graphics information from the graphics server. If the capabilities of the display unit 102 differ from the color information then the color information for the abstract representation is converted into color information that correlates with the display unit's 102 capabilities. For example, if the color complexity of the abstract representation is in the RGB (Red-Green-Blue) color model and the display unit 102 presents greyscale images then the abstract representation's color information is converted accordingly. The color modification mechanism 200 converts any color information from the abstract representation to any color system support by the remote computing device 56, such as, ARGB/RGBA (alpha-red-green-blue), RGB (24 bits), RGB (16 bits), RGB (12 bits), paletted color systems, greyscale (8 bits), greyscale (4 bits) and black and white).

During the conversion between color information complexities, the color modification mechanism 200 identifies the complexity of the color information in the abstract representation as well as the complexity of the color information that can be presented on the display unit 102 as indicated in the device profile. The conversion between the color information complexities can be performed according to any of a number of conversion algorithms known in the art.

Conversion of the complexity of the color information may also be performed on the basis of the capabilities of the graphics interpretation mechanism 104. While the display unit 102 may be configured to display any color system, the graphics interpretation mechanism 104 may only be able to interpret a limited number of all possible colors (i.e. a limited color palette). The color modification mechanism 200 identifies the color information complexity of the abstract representation and converts it to the same color information complexity as the display unit 102. The color modification mechanism 200 identifies the color information complexity of the graphics interpretation mechanism 104. The color information complexity for the abstract representation is restricted to include at most the number of colors in the color palette of the graphics interpretation mechanism 104. Restriction of color information complexity in the abstract representation may be performed according to any of a number of algorithms known in the art, such as, building a histogram representation of the colors in the abstract representation and reducing the number of colors based on color frequency and color differentiation.

Unification of color presentation occurs when graphics information is spread over multiple viewing pages or originates from multiple files. If the graphics information requested by the remote computing device 56 is in multiple files when obtained from the graphics server, each file may contain different complexities of color information. If these files are to remain separate then the color modification mechanism 200 ensures uniformity among all of the separate files after color information complexity conversion has been performed. Any of a number of known techniques for ensuring color information uniformity between multiple files may be used. For example, a histogram may be produced for the color information for each file and the results of each histogram may be mapped against each file to produce a single color palette for all files. The color information for each file may then be converted to conform to the determined single color palette.

If the files are to be merged into a single abstract representation then the color information for each file may be mapped to a single color complexity and color format before merging.

Changing the manner in which colors are represented is performed to align the color information format of the abstract information with that of the display unit 102. Color information may be represented in a number of different formats including CMYK (cyan-magenta-yellow-black), RGB, HIS (hue-saturation-intensity) and CIE XYZ (Commission Internationale de l'Eclairage). The color modification mechanism 200 determines the color information format of the abstract representation and the color information format of the display unit 102 as indicated by the device profile. The color modification mechanism 200 converts the color information format of the abstract representation to that of the display unit 102 according to any of a number of conversion algorithms known in the art.

Manipulation of the shading and filling information by the color modification mechanism 200 may involve converting the shading and filling information of the abstract representation to a form corresponding to that indicated in the device profile. A graphics object can have filled (painted interior) or stroked (painted outline) shapes and text where color, gradients (linear or radial) or patterns (vector, images or tiled) are used. Gradients consist of continuously smooth color transitions along a vector from one color to another, possibly followed by additional transitions along the same vector to other colors). Patterns and gradients may be used to fill or stroke an object. Patterns may replicate a pre-defined graphic object at fixed intervals in the standard x and y axis direction to cover the area to be painted. For example, if the graphics interpretation mechanism 104 or the display unit 102 are not provided with the ability to display gradient fills or pattern fills then these fills are converted to a solid fill. The color modification mechanism 200 receives information on the shading and filling that can be displayed by the display unit 102 and graphics interpretation mechanism 104 from the device profile and shading and filling information from the abstract representation. The shading and filling information for the abstract representation is conformed to the shading and filling capabilities indicated in the device profile. Conversion of the shading and filling information may be performed according to any of a number of known algorithms. For example, converting a gradient fill to a solid fill may be performed using the midpoint of the gradient color.

A graphics modification mechanism 202 manipulates the geometric representation of objects in the abstract representation. The graphics modification mechanism 202 performs geometric manipulations to provide objects with a geometric shape that is displayable by the remote computing device 56. The geometric manipulation may include converting curve formats, performing affine transformation and converting caps and joins.

Conversion of the curve formats in the abstract representation may involve converting curve segment objects in formats that cannot be displayed and interpreted by the remote computing device 56 into a series of line segment objects. Curve format conversion may also be performed to reduce the amount of data used to describe a curve object, thereby reducing the transmission size of graphics information. The curve format may be, for example, a cubic bezier, a shorthand cubic bezier, a quadratic bezier, a shorthand/smooth quadratic bezier or an elliptical arc. The graphics modification mechanism 202 determines the curve format for each curve object in the abstract representation and the curve format capabilities indicated in the device profile. The graphics modification mechanism 202 aligns the curve format of each curve object in the abstract presentation with the curve format in the device profile according to any one of a number of curve conversion techniques known in the art.

Affine transformations may be performed on the abstract representation by the graphics modification mechanism 202 to avoid having the graphics interpretation mechanism 104 perform this manipulation. Performing manipulation and transformations before transmitting the graphics information reduces the amount of processing that is done by the graphics interpretation mechanism 104 for displaying the graphics information. This allows effects that use larger amounts of computing resources than are available on the remote computing device 56 to be incorporated into the graphics information before transmission to the remote computing device 56. The graphics modification mechanism 202 may perform any one of a number of affine transformation algorithms known in the art.

Conversion of the caps and joins format(s) in the abstract representation may involve converting linecaps and linejoins objects into formats that can be displayed and interpreted by the remote computing device 56. The linecaps objects, shape used at the end of open subpaths when they are stroked, may be, for example, butt, round, or square. The linejoins objects, shape used at the corners of paths, may be, for example, miter, round or beveled. The graphics modification mechanism 202 determines the format of each linecap and linejoin object in the abstract representation and the format(s) that can be displayed and interpreted by the remote computing device 56 as indicated in the device profile. The graphics modification mechanism converts the linecaps and linejoins formats in the abstract representation that cannot be displayed and interpreted into format(s) that can be displayed and interpreted according to known linecap and line join format conversion techniques.

A display adaptation mechanism 204 manipulates the abstract representation to provide graphics information that is aligned with the size of the display as indicated in the device profile. The display adaptation mechanism 204 may perform such operations as file merging, script incorporation and display region clipping.

The display adaptation mechanism 204 may incorporate multiple files belonging to the requested graphic information into a single abstract representation. The resulting abstract representation may span multiple pages, based on the size of the display unit 102, and may include graphics information that was in multiple formats when received from the graphics server. If a specific single page has been requested by the remote computing device 56 then the display adaptation mechanism 204 creates a separate abstract representation containing only the requested page.

Script functions referenced in the abstract representation are determined by the display adaptation mechanism 204 to retrieve the script or outcome of the script for incorporation into the abstract representation. Similar to file merging, script incorporation involves determining the outcome of the script and merging the script outcome with the abstract representation.

The display adaptation mechanism 204 determines the size of the display of the graphics information embodied in the abstract representation and the size of the display unit 102 as indicated in the device profile. The display adaptation mechanism 204 aligns the size of the display of the abstract representation with that of the display unit 102. This may be accomplished by reducing any raster data from the abstract representation to a size more adapted for the remote computing device 56. The reduction can be done according to any one of a number of techniques known in the art such as interpolation or decimation.

A text conversion mechanism 206 converts the format of any text objects in the abstract representation into a format that can be interpreted by the graphics interpretation mechanism 104. The graphics interpretation mechanism 104 may render the format in a stroke font format or a raster font format. The stroked font format uses vectors (non-outline) and is capable of scaling and rotation. The raster font format uses bitmaps and scales according to integers (e.g. 2, 3, etc.) and rotations of 90°. The text conversion mechanism 206 examines all text objects in the abstract representation to determine all font formats used by the graphics information. The text conversion mechanism 206 converts the format of the text objects to provide a consistent format between different text objects and to provide the text objects in a format that can be interpreted by the graphics interpretation mechanism 104. Conversion of text objects between formats can be performed according to any of a number of techniques known in the art.

A transmission size adaptation mechanism 210 manipulates the abstract representation to produce graphics information that is of a transmission size that is compatible with the communication link between the graphics manipulation system 110 and the remote computing device 56. That is, the transmission size adaptation mechanism 210 reduces the transmission size of the graphics information to avoid lengthy transmission times when the capacity of the communications link is small. Based on the remote computing device profile the transmission size adaptation mechanism 210 determines a desirable size for the graphics information using information on the capacity of the remote computing devices' data storage 106 and the capacity of the communications link.

The abstract representation is manipulated by the transmission size adaptation mechanism 210 to provide a sufficient reduction in the graphics information size. These reductions can be implemented using known techniques such as removing redundant information, removing non-visual elements, bitmap re-sampling, simplifying complex shapes, reducing the resolution of the graphics information and reducing the complexity of the coordinate system used for representing the graphics information. Removal of redundant information involves finding objects in the abstract representation with common properties and grouping these objects in such a way that the properties are not repeatedly represented. Removal of non-visual elements involves removing any objects that are not visually represented in the graphics information such as comments, empty groups, invisible shapes, shapes outside of a determined clipping region, etc. Bitmap re-sampling involves reducing the resolution of bitmap format graphics information as their size while maintaining an acceptable visual quality. Simplification of complex shapes involves replacing complex shapes (such as polyline, path, polygon, curves, etc.) with visually similar shapes (such as rectangle, line, circle, etc.). Reduction in image resolution may involves reducing portions of the graphics information in the abstract representation having a higher resolution than can be viewed by the remote computing device 56. Reduction of the complexity of the coordinate system used to represent the graphics information may include, for example, converting multiple unites (e.g. centimeter, inches, etc.) and floating point user coordinate to an integer space.

A format conversion mechanism 208 converts the abstract representation into a format that can be interpreted by the remote computing device 56. After the abstract representation has been manipulated by the other mechanisms 200 to 210 into a form that corresponds with the capabilities of the remote computing device 56, the abstract representation is provided to the format conversion mechanism 208 with indication of a format that can be interpreted by the graphics interpretation mechanism 104. The format conversion mechanism 208 performs the opposite action of the graphics abstraction mechanism 116 by converting the abstract representation into graphics information, although possibly in a different format than the original graphics information. The final graphics information produced by the format conversion mechanism 208 should be small, simple and flexible enough to support various device types. The final format of the graphics information should also support a number of geometric shapes and graphical objects as well as different color systems. Text and font information should also be supported by the final format.

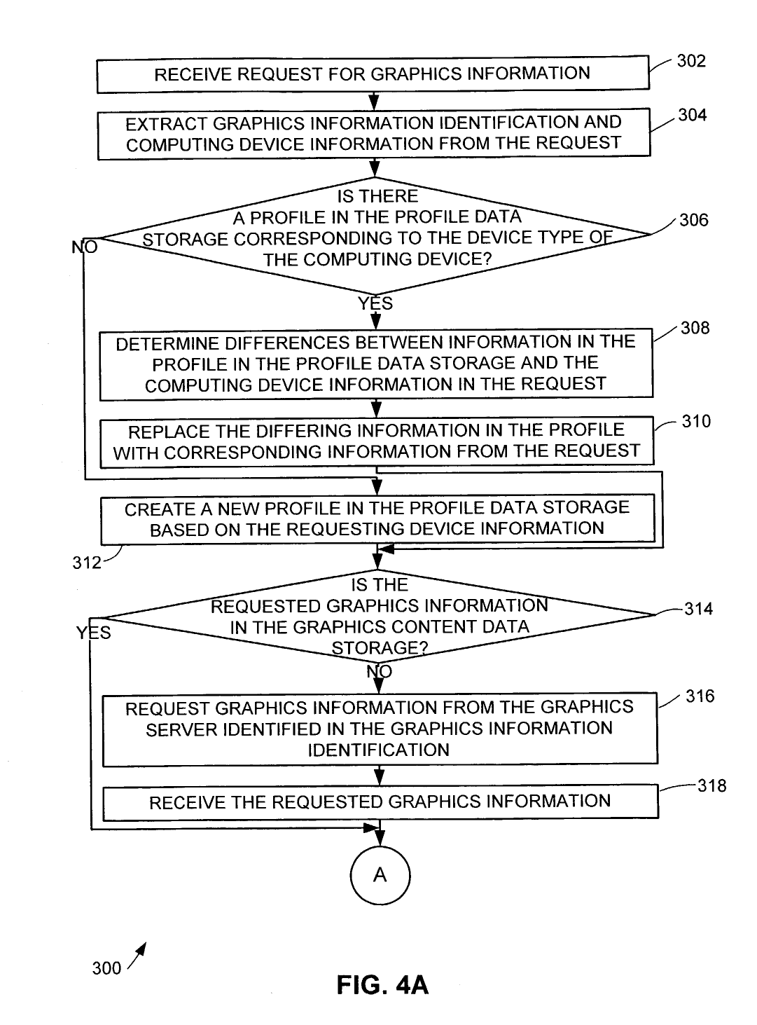

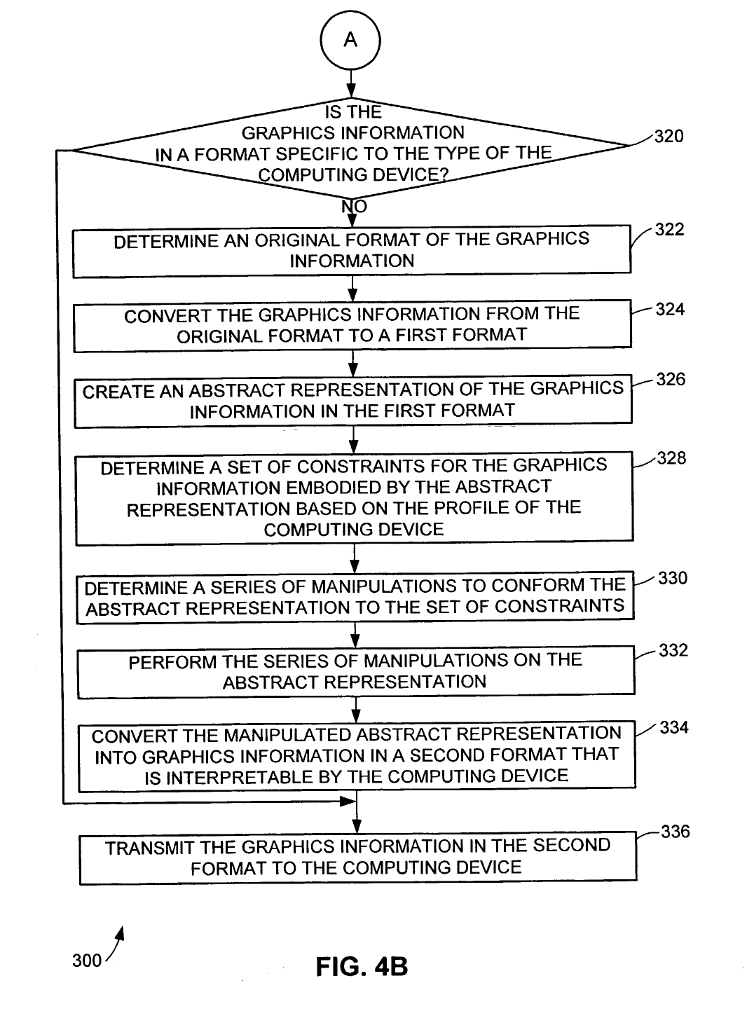

FIGS. 4A and B show a method 300 of manipulating graphics information at the graphics manipulation system 110 according to the remote computing device 56 on which the graphics information is to be displayed. A request for graphics information is received in step 302 from the remote computing device 56. The portions in the request providing content are extracted in step 304. Identification information for the requested graphics information is extracted along with information on the remote computing device 56.

The profile data storage 118 is searched in step 306 to determine if it contains a profile corresponding to the device type of the remote computing device 56. If a corresponding device profile is found in the profile data storage 118 then the differences between the device information in the request and the profile is determined in step 308. The profile is then updated in step 310 by differing information in the profile with the corresponding information from the remote computing device 56 information from the request. If a corresponding device profile is not found in the profile data storage 118, then a new profile is created based on the remote computing device 56 information in the request in step 312.

After a profile has been created or determined then the graphic content data storage 122 is searched to determine if the graphics information identified in the request is in the data storage 122 in step 314. If the requested graphics information is not in the graphic content data storage 122 then the graphics information is requested from the graphics server identified in the request in step 316. The requested graphics information is received from the graphics server in step 318.

After the graphics information has been received or retrieved from the graphic content data storage 122, it is determined if the graphics information in a format specific for the remote computing device 56 in step 320. That is, it is determined in step 320 if the graphics information has been customized for the remote computing device 56. If the graphics information is in an unspecified format then the original format of the graphics information is determined in step 322. The graphics information is converted from the original format to a first format in step 324. This produces graphics information in a single format that may have originally been in multiple formats. An abstract representation of the graphics information in the first format is created in step 326.

A set of constraints are determined in step 328 for the graphics information embodied by the abstract represented based on the profile of the remote computing device 56. These constraints take into consideration the capabilities of the remote computing device 56 in such areas as display size and color, memory capacity, transmission link capacity, etc. A series of manipulations is determined in step 330 that will conform the abstract representation to the set of constraints to produce graphics information that can be displayed and interpreted by the remote computing device 56. These manipulations are systematically performed on the abstract representation in step 332. The manipulations may include such actions as changing the colors used in the abstract representation, changing the representation of colors, unifying color presentation over multiple files, converting shading and filing information, converting curve object format, performing affine transformations, converting cap and join object format, conforming display size with that of the display unit 102, converting text form, reducing transmission size, etc. The manipulated abstract representation is converted in step 334 is converted into graphics information in a second format that is interpretable by the remote computing device 56.

The graphics information in the second format, either obtained from the graphic content data storage 122 or the manipulated abstract representation, is transmitted to the remote computing device in step 336.

Manipulation of graphics information according to a computing device on which graphics information is to be displayed is performed. The capabilities of the computing device are used to form a set of constraints for the graphics information obtained from a content provider. These constraints take into consideration such factors as display characteristics of the computing device, processing power, available memory and communication capacity. The graphics information is manipulated to conform to the set of constraints, resulting in graphics information that can be displayed and interpreted by the computing device.

While the method disclosed herein has been described and shown with reference to particular steps performed in a particular order, it will be understood that steps may be combined, subdivided or reordered to form an equivalent method without departing from the teachings of the present invention. Accordingly, unless specifically indicated herein, the order and grouping of the steps if not a limitation of the present invention.

It is apparent to one skilled in the art that numerous modifications and departures from the specific embodiments described herein may be made without departing from the spirit and scope of the invention.

1. A method of modifying graphics information to be displayed on a computing device having a set of display characteristics representing display capabilities of the computing device, said method comprising:
determining a scheme by which to conform characteristics of the graphics information to the set of display characteristics; and
harmonizing the characteristics of the graphics information to the set of display characteristics according to said scheme to provide the graphics information in a format adapted for the set of display characteristics.

2. The method according to claim 1 further including, prior to the step of determining:
receiving a request for modification of the graphics information, said request including an indication of the set of display characteristics of the computing device; and
obtaining the graphics information in accordance with said request.

3. The method according to claim 2 wherein said scheme is based on said indication of the set of display characteristics in said request.

4. The method according to claim 1 further including:
converting the graphics information to a first format, prior to harmonizing the characteristics of the graphics information.

5. The method according to claim 4 further including:
creating an abstract representation of the graphics information in the first format, wherein the first format is suitable for facilitating creation of said abstract representation.

6. The method according to claim 5 wherein the step of determining includes:
determining the characteristics of the graphics information using said abstract representation.

7. The method according to claim 6 wherein the step of determining includes:
determining a set of graphics display constraints for the computing device based on the set of display characteristics; and
determining a set of manipulations to conform the characteristics of the graphics information to said set of graphics display constraints; and
constructing said scheme to apply each manipulation in said set of manipulations to said abstract representation in a predetermined order; and wherein the step of harmonizing includes:
applying said scheme to the graphics information by applying each manipulation in said set of manipulations to said abstract representation in said predetermined order to provide the graphics information in the adapted for the set of display characteristics.

8. The method according to claim 1 wherein the step of determining includes:
determining a set of graphics display constraints for the computing device based on the set of display characteristics; and
determining a set of manipulations to conform the characteristics of the graphics information to said set of graphics display constraints; and
constructing said scheme to apply each manipulation in said set of manipulations to the graphics information in a predetermined order.

9. The method according to claim 8 wherein the step of harmonizing includes:
applying said scheme to the graphics information by applying each manipulation in said set of manipulations to the graphics information in said predetermined order to provide the graphics information in the adapted for the set of display characteristics.

10. The method according to claim 1 further including:
providing the graphics information in the format adapted for the set of display characteristics to the computing device for display thereon.

11. The method according to claim 1 further including:
interpreting the graphics information in the format adapted for the set of display characteristics to provide the graphics information in a format interpretable by the computing device for display thereon; and
wherein the format adapted for the set of display characteristics is independent of a type of the computing device.

12. The method according to claim 1 wherein said scheme may be determined to optimize a speed at which the graphics information is provided to the computing device and a speed at which the computing device display the graphics information

13. A system for modifying graphics information to be displayed on a computing device having a set of display characteristics representing display capabilities of the computing device, said system comprising:
a conformation mechanism for assessing the set of display characteristics and characteristics of the graphics information to determine a scheme by which to conform the characteristics of graphics information to the set of display characteristics;
a graphics modification mechanism for harmonizing the characteristics of the graphics information to the set of display characteristics according to said scheme; and
a controller for orchestrating modification of the graphics information to provide the graphics information in a adapted for the set of display characteristics.

14. The system according to claim 13 further including:
a graphics obtainment mechanism for receiving a request for modification of the graphics information and obtaining the graphics information accordingly, said request including an indication of the set of display characteristics of the computing device.

15. The system according to claim 14 further including:
a request dissection mechanism for obtaining the set of display characteristics from said request.

16. The system according to claim 13 further including:
a format conversion mechanism for converting the graphics information to a first format.

17. The system according to claim 16 further including:
a graphics abstraction mechanism for creating an abstract representation of the graphics information; and
wherein said first format is suitable for facilitating creation of said abstract representation.

18. The system according to claim 17 wherein said conformation mechanism includes:
a characteristic interpretation mechanism for determining a set of graphics display constraints for the computing device based on the set of display characteristics and determining a set of manipulations to conform characteristics of the graphics information to said set of constraints; and
a control mechanism for constructing said scheme to apply each manipulation in said set of manipulations to said abstract representation in a predetermined order; and wherein said graphics harmonization mechanism includes:
a manipulation mechanism for applying said scheme to the graphics information by applying each manipulation in said set of manipulations to said abstract representation in said predetermined order to provide the graphics information in the format adapted for the set of display characteristics.

19. The system according to claim 13 wherein said conformation mechanism includes:
a characteristic interpretation mechanism for determining a set of graphics display constraints for the computing device based on the set of display characteristics and determining a set of manipulations to conform characteristics of the graphics information to said set of constraints; and
a control mechanism for constructing said scheme to apply each manipulation in said set of manipulations to said abstract representation in a predetermined order.

20. The system according to claim 19 wherein said graphics harmonization mechanism includes:
a manipulation mechanism for applying said scheme to the graphics information by applying each manipulation in said set of manipulations to the graphics information in said predetermined order to provide the graphics information in the format adapted for the set of display characteristics.

21. The system of claim 13 further including:
a communications module for providing the harmonized graphics information in the format adapted for the set of display characteristics to the computing device for display thereon.

22. The system according to claim 13 further including:
a graphics interpretation mechanism for the computing device to interpret the graphics information in the format adapted for the set of display characteristics for provision of the graphics information in a format interpretable by the computing device for display thereon; and
wherein the format adapted for display is independent of a type of the computing device.

23. The system according to claim 13 wherein said scheme may be determined to optimize a speed at which the graphics information is provided to the computing device and a speed at which the computing device display the graphics information

24. A computer readable medium having stored thereon computer-executable instructions for modifying graphics information to be displayed on a computing device having a set of display characteristics representing display capabilities of the computing device, said computer-executable instructions comprising:
determining a scheme by which to conform characteristics of the graphics information to the set of display characteristics;
harmonizing the characteristics of the graphics information to the set of display characteristics according to said scheme to provide the graphics information in a format adapted for the set of display characteristics.

25. The computer-executable instructions according to claim 24 further including, prior to the step of determining:
receiving a request for modification of the graphics information, said request including an indication of the set of display characteristics of the computing device; and
obtaining the graphics information in accordance with said request.

26. The computer-executable instructions according to claim 25 wherein said scheme is based on said indication of the set of display characteristics in said request.

27. The computer-executable instructions according to claim 24 further including:
converting the graphics information to a first format, prior to harmonizing the characteristics of the graphics information.

28. The computer-executable instructions according to claim 27 further including:
creating an abstract representation of the graphics information in the first format, wherein the first format is suitable for facilitating creation of said abstract representation.

29. The computer-executable instructions according to claim 28 wherein the step of determining includes:
determining the characteristics of the graphics information using said abstract representation.

30. The computer-executable instructions according to claim 29 wherein the step of determining includes:
determining a set of graphics display constraints for the computing device based on the set of display characteristics; and
determining a set of manipulations to conform the characteristics of the graphics information to said set of graphics display constraints; and
constructing said scheme to apply each manipulation in said set of manipulations to said abstract representation in a predetermined order; and wherein the step of harmonizing includes:
applying said scheme to the graphics information by applying each manipulation in said set of manipulations to said abstract representation in said predetermined order to provide the graphics information in the format adapted for the set of display characteristics.

31. The computer-executable instructions according to claim 24 wherein the step of determining includes:
determining a set of graphics display constraints for the computing device based on the set of display characteristics;
determining a set of manipulations to conform the characteristics of the graphics information to said set of graphics display constraints; and
constructing said scheme to apply each manipulation in said set of manipulations to the graphics information in a predetermined order.

32. The computer-executable instructions according to claim 31 wherein the step of harmonizing includes:
applying said scheme to the graphics information by applying each manipulation in said set of manipulations to the graphics information in said predetermined order to provide the graphics information in the adapted for the set of display characteristics.

33. The computer-executable instructions according to claim 24 further including: providing the graphics information in the format adapted for the set of display characteristics to the computing device for display thereon.

34. The computer-executable instructions according to claim 24 further including:
interpreting the graphics information in the format adapted for the set of display characteristics at the computing device to provide the graphics information in a format interpretable by the computing device for display thereon; and
wherein the format adapted for the set of display characteristics is independent of a type of the computing device.

35. The computer-executable instructions according to claim 24 wherein said scheme may be determined to optimize a speed at which the graphics information is provided to the computing device and a speed at which the computing device display the graphics information
